(19) United States
(12) Patent Application Publication
(10) Pub. No.: US 2006/0220811 A1
(43) Pub. Date: Oct. 5, 2006

(54) Method for indirectly identifying the loss of pressure on a motor vehicle wheel

(76) Inventors: Martin Griesser, Eschborn (DE); Andreas Köbe, Bensheim (DE); Frank Edling, Chiba (JP); Vladimir Koukes, Darmstadt (DE)

Correspondence Address: Gerlinde M Nattler;Craig Hallacher, Continental Teves Inc, One Continental Drive, Auburn Hills, MI, 48326, US

(21) Appl. No.: 10/538,952

(22) PCT Filed: Dec. 10, 2003
(86) PCT No.: PCT/EP03/13987

§ 371 Date: Apr. 18, 2006

(30) Foreign Application Priority Data
Dec. 17, 2002 (DE) 102 59 201.2

(51) Int. Cl. B60C 23/06

(52) U.S. Cl. 340/442; 73/146

(57) ABSTRACT

Disclosed is a method for indirectly identifying the loss of pressure on a motor vehicle wheel, with the wheel acceleration a_{wheel} being evaluated. Also disclosed is a computer program product defining an algorithm that comprises a method for the indirect pressure loss detection on a motor vehicle wheel.

### BACKGROUND OF THE INVENTION

The present invention relates to a method for indirectly identifying the loss of pressure on a motor vehicle wheel, and to a computer program product including an algorithm defining the method.

Methods for the indirect detection of tire pressure loss (DDS) are known, e.g. from DE 100 58 140 A1, being based on a measurement of rolling radii of the wheels of a vehicle. Ratios are produced from these measured variables. The ratios are learnt and subsequently used as reference values. Deviations from the reference values are interpreted as tire pressure loss.

DE 100 44 114 A1 discloses another method and a device for detecting pressure loss in tires of motor vehicles by means of a plausibility check. The reference values defined in this publication for detecting a pressure loss are tested in the plausibility check in order to avoid or minimize spurious alarms.

WO 2000006433 A1 discloses a method for detecting rough road sections that is used for vehicle speed control.

A shortcoming involved with the above prior art pressure loss detection methods is that these methods are always based on deviations of the individual wheels relative to each other, with the result that pressure loss on more than one tire is not always detectable. Hence, especially the detection of pressure loss on several or all of the tires is not always possible.

Further methods are known in the art performing tire pressure loss detection by means of a frequency analysis. In this analysis, a shift of maximum values in the frequency spectrum is interpreted as tire pressure loss. This approach requires very intensive calculating operations and great resources in working memories (RAM).

### SUMMARY OF THE INVENTION

In view of the above, an object of the invention is to provide a method allowing a low-cost and reliable detection of pressure losses even on several or all of the wheels.

According to the invention, this object is achieved by a method for indirectly detecting pressure loss of a motor vehicle wheel.

It is preferred to monitor the wheel acceleration within a predetermined time for all wheels and evaluate deviations in the wheel acceleration. In this case, wheel acceleration is preferably evaluated only if defined driving maneuvers or driving conditions prevail. Straight travel is considered to be an especially preferred driving condition. Straight travel is preferably detected by evaluation of driving parameters such as the lateral acceleration of the vehicle, longitudinal acceleration of the vehicle, yaw rate, wheel torques, etc. These driving parameters can be measured by means of sensors or calculated from other variables. Partly, a vehicle data bus (CAN) can interrogate these driving parameters being available also to other systems such as an anti-lock system (ABS) or a traction control system (TCS) or an electronic stability program (ESP).

Further, it is preferred that the wheel acceleration is evaluated only starting from a minimum speed of the vehicle. Preferably, the evaluation of the wheel acceleration is executed only if the driving parameters are below certain limit values describing straight travel.

Preferably, a difference between the minimum and the maximum of the wheel acceleration is produced for each vehicle wheel. It is further preferred that instead of the difference, the amount or only the positive or negative acceleration values of maximum and minimum are produced and evaluated.

Preferably, a reference value is produced from the difference of each individual vehicle wheel representing an arithmetic mean value of the difference as a function of time T1 or a filtered value of the difference in a particularly preferred fashion. This filtered value is preferably obtained in a filtering operation of first order.

The limit value THRESH 1 is preferably determined depending on the wheel torque applied to the vehicle wheel. In an especially preferred manner, different limit values THRESH 1 are fixed for a driven axle and a freely rolling axle.

A warning given to the vehicle driver is preferably suppressed when a vehicle wheel has exceeded the limit value THRESH 1 and at least one other vehicle wheel has exceeded a second limit value THRESH 2.

Preferably, the method of the invention is employed in conjunction with a known indirectly measuring tire pressure monitoring system (DDS) and/or a known directly measuring tire pressure monitoring system (TPMS), which latter system is used only for the supplementary review or improvement of the known indirectly measuring tire pressure monitoring system (DDS) and/or a known directly measuring tire pressure monitoring system (TPMS).

### BRIEF DESCRIPTION OF THE DRAWINGS

Further features and advantages of the method of the invention are described below. The invention is described by way of three Figures. In the Figures,

FIG. 1 shows the wheel acceleration as a function of time.

FIG. 2 shows the wheel torque as a function of the vehicle speed.

FIG. 3 shows the difference Sample_acc as a function of time.

### DETAILED DESCRIPTION OF THE DRAWINGS

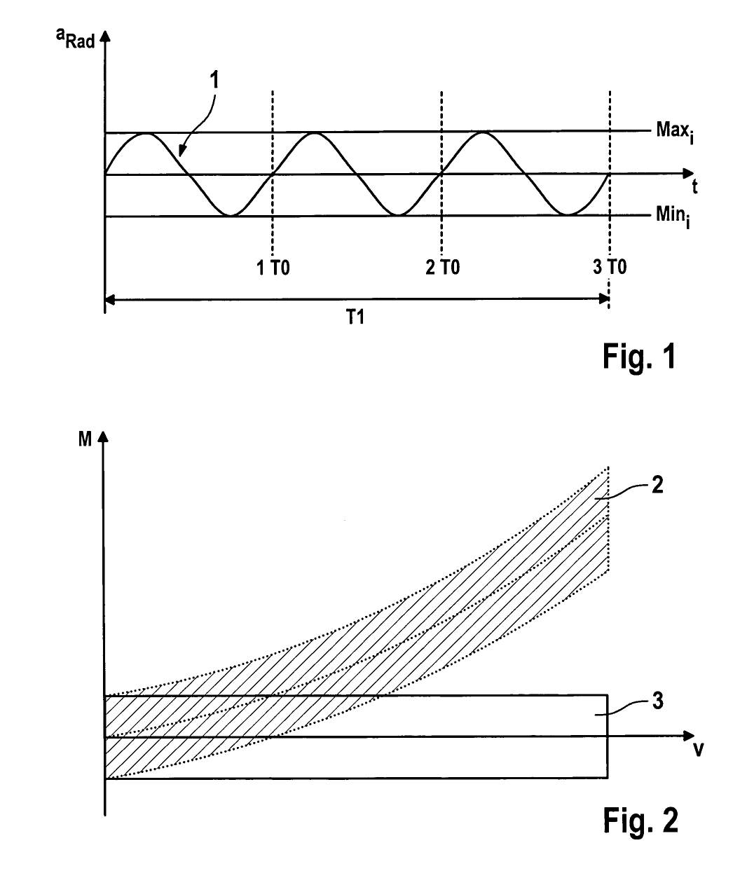

With reference to FIG. 1, curve 1 represents a possible variation of the wheel acceleration a_{wheel} of a vehicle wheel as a function of time t. The wheel acceleration a_{wheel} is monitored in each case over time intervals T0 and a difference Sample_acc is formed that is composed of the maximum Maxᵢ and the minimum Minᵢ of each wheel I within this time interval T0. Over a time T1 comprising several time intervals T0, a reference value Ref_DIFF for the wheel acceleration a_{wheel} of each individual wheel I is determined and stored.

With reference to FIG. 2, the wheel torque M of a vehicle wheel is plotted against the vehicle speed v. As the vehicle speed v not only depends on the wheel torque M but also on other parameters such as the coefficient of friction between roadway and tires, so-called wheel torque ranges are produced, as is illustrated in curves 2 and 3. In this respect, the wheel torque ranges describe for each vehicle speed v a valid range in which wheel torque M of an intact vehicle wheel can be. If wheel torque M at a vehicle speed v is outside the valid range, this implies that there is a tire defect, for example. Curve 2 in this regard describes the valid wheel torque range of a driven vehicle wheel plotted against the vehicle speed v, while curve 3 represents a typical variation of the wheel torque range of a freely rolling or non-driven vehicle wheel of a driven axle as a function of the vehicle speed v. This method can be employed both for a vehicle with a driven axle and for a vehicle with two driven axles. In locking differentials the wheel torque distribution is calculated depending on the degree of locking. This degree of locking either prevails on the vehicle data bus (CAN) or can be determined from the wheel speed differences, e.g. in cornering maneuvers, by comparing the yaw rate/lateral acceleration with the measured values or, respectively, in a longitudinal direction by comparing the slip at the front wheels in comparison with the rear wheels as a function of the wheel torque.

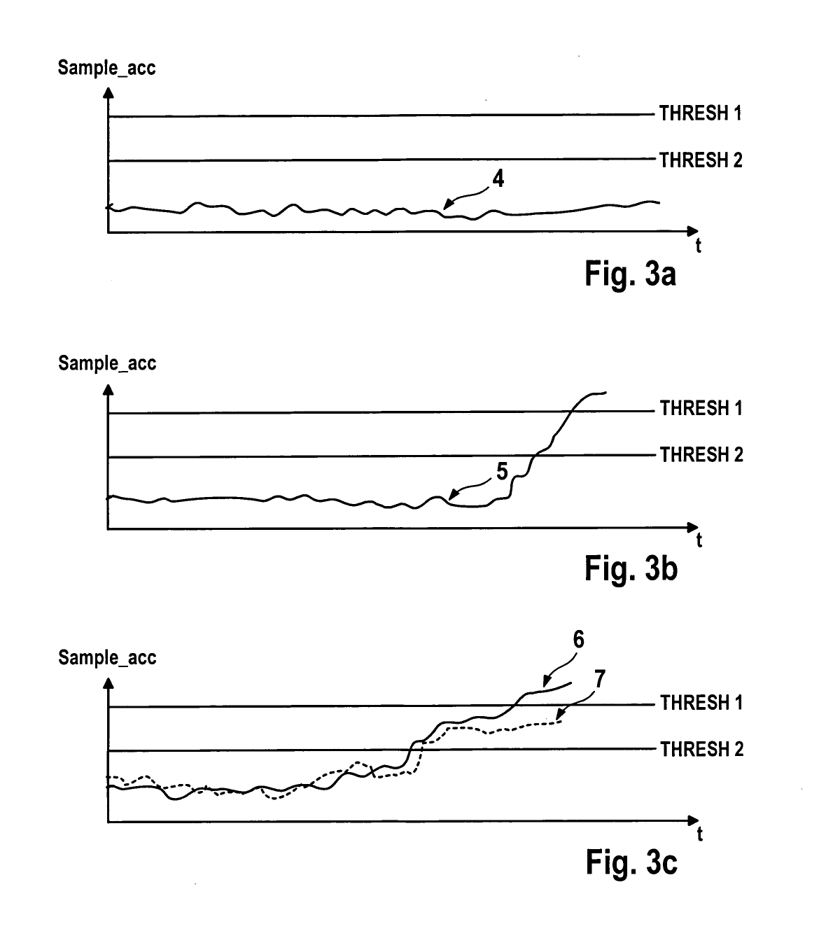

The difference Sample_acc of the wheel acceleration a_{wheel} is plotted against time t in FIG. 3. FIG. 3a represents in curve 4 a possible variation of a difference Sample_acc1 of a wheel as a function of time t without exceeding a limit value THRESH 1 or THRESH 2. In FIG. 3b, the difference Sample_acc2 of a wheel illustrated in curve 5 exceeds the limit values THRESH 1 and THRESH 2. In FIG. 3c likewise a difference Sample_acc3 of a wheel illustrated in curve 6 exceeds the limit values THRESH 1 and THRESH 2, while a difference Sample_acc4 or another wheel, illustrated in curve 7, exceeds only the limit value THRESH 2.

An example of the method of the invention will be described hereinbelow by way of individual steps making reference to the FIGS. 1 to 3.
1. A selection of driving maneuvers is defined that allow evaluation (e.g. all DDS-relevant driving maneuvers such as straight travel). Straight travel is detected by evaluating driving parameters such as lateral acceleration, longitudinal acceleration, yaw rate, wheel torques, etc. These driving parameters can be measured by sensors, calculated from other variables or interrogated by means of a vehicle data bus (CAN), in which these driving parameters are already made available to or also used in other systems such as an anti-lock system (ABS), a traction control system (TCS) or an electronic stability program (ESP). The wheel acceleration a_{wheel} is only evaluated starting from a vehicle minimum speed of roughly 15 km/h.
2. The maximum MAXᵢ and the minimum MINᵢ of the wheel acceleration a_{wheel} (see FIG. 1) of a wheel I is determined over a time interval T0. This is done for all n wheels of the vehicle.
3. The difference or the amount or only the positive or negative acceleration values of maximum and minimum are produced and evaluated:
4. Sample_{—}acc=MAXᵢ−MINᵢ.
5. This difference Sample_acc is monitored for a time T1 stretching over several time intervals T0, and a reference value Ref_DIFF is stored. This can be the arithmetic mean value or a filtered value, e.g. filtered by means of a first-order filter.
6. The difference Sample_acc (see FIG. 3) is monitored further, and an alarm is issued upon exceeding of a limit value THRESH1 that is responsive to wheel torque only after a statistic safeguard, this may be an appropriately small standard deviation, for example.
7. Plausibility operations take place so that alarms are suppressed if other mechanisms have detected e.g. a rough road section or all four wheels exceed a limit value THRESH 2 (see FIG. 3) which is lower than the limit value THRESH 1 responsive to wheel torque.
8. In another embodiment of the invention, the limit values THRESH 2 can be set individually for each wheel or in pairs, in each case the driven or the non-driven wheels, respectively. Further, separate selection criteria for THRESH 1 are set depending on whether a torque is or is not applied to this wheel at this moment.

All suppression mechanisms, or parts thereof, are used that are already provided in other systems (e.g. in an indirect tire pressure loss detection system, ABS, TCS, ESP, etc.).

1-10. (canceled)

11. A method for indirectly detecting pressure loss on a motor vehicle wheel, the method comprising:
determining one or more parameters used to determine pressure loss of a motor vehicle wheel, wherein the one or more parameters is derived from a wheel acceleration.

12. The method according to claim 11 further comprising:
evaluating the wheel acceleration when one or more defined driving conditions prevail, wherein straight travel is one of the defined driving conditions.

13. The method according to claim 12, wherein a minimum and a maximum of the wheel acceleration of each individual vehicle wheel is determined in a predetermined time interval (T0).

14. The method according to claim 13, wherein a difference (Sample_acc) is produced, for each wheel, from the minimum and the maximum of the wheel acceleration.

15. The method according to claim 14, wherein a reference value is produced from the differences (Sample_acc) of the individual time intervals (T0) over a time (T1) stretching over several time intervals (T0).

16. The method according to claim 15, wherein an alarm is triggered when the difference (Sample_acc) exceeds a first limit value (THRESH 1).

17. The method according to claim 16, wherein the alarm is suppressed when at least one further difference (Sample_acc) of another vehicle wheel has exceeded a second limit value (THRESH 2).

18. The method according to claim 16, wherein the alarm is suppressed when one or more situations is detected in the vehicle, wherein the one or more situations include at least one of a rough road section, a non-uniform roadway coefficient of friction, or driving on snow and ice.

19. The method according to claim 10, wherein evaluation of the wheel acceleration is suppressed when other systems influencing the wheel acceleration, such as an anti-lock system, traction control system, electronic stability system, etc., are active.

20. A computer program product for indirectly detecting pressure loss on a motor vehicle wheel, said computer program comprising:
a code segment for determining one or more parameters used to determine pressure loss of a motor vehicle wheel, wherein the one or more parameters is derived from a wheel acceleration.

21. The computer program according to claim 20 further comprising:
a code segment for evaluating the wheel acceleration when one or more defined driving conditions prevail, wherein straight travel is one of the defined driving conditions.

22. The computer program according to claim 21, wherein a minimum and a maximum of the wheel acceleration of each individual vehicle wheel is determined in a predetermined time interval (T0).

23. The computer program according to claim 22, wherein a difference (Sample_acc) is produced, for each wheel, from the minimum and the maximum of the wheel acceleration.

24. The computer program according to claim 23, wherein a reference value is produced from the differences (Sample_acc) of the individual time intervals (T0) over a time (T1) stretching over several time intervals (T0).

25. The computer program according to claim 24, wherein an alarm is triggered when the difference (Sample_acc) exceeds a first limit value (THRESH 1).

26. The computer program according to claim 25, wherein the alarm is suppressed when at least one further difference (Sample_acc) of another vehicle wheel has exceeded a second limit value (THRESH 2).

27. The computer program according to claim 25, wherein the alarm is suppressed when one or more situations is detected in the vehicle, wherein the one or more situations include at least one of a rough road section, a non-uniform roadway coefficient of friction, or driving on snow and ice.

28. The computer program according to claim 20, wherein evaluation of the wheel acceleration is suppressed when other systems influencing the wheel acceleration, such as an anti-lock system, traction control system, electronic stability system, etc., are active.
